(19) United States
(12) Patent Application Publication
(10) Pub. No.: US 2026/0005759 A1
(43) Pub. Date: Jan. 1, 2026

(54) TIME-INTERLEAVED PHASE-OTDR WITH NESTED PHASE REFERENCES

(71) Applicant: NEC Laboratories America, Inc., Princeton, NJ (US)

(72) Inventors: Ezra IP, West Windsor, NJ (US); Yue-Kai HUANG, Princeton, NJ (US); Fatih YAMAN, Princeton, NJ (US)

(73) Assignee: NEC Laboratories America, Inc., Princeton, NJ (US)

(21) Appl. No.: 19/248,460

(22) Filed: Jun. 25, 2025

Related U.S. Application Data
(60) Provisional application No. 63/666,283, filed on Jul. 1, 2024.

(51) Int. Cl. H04B 10/071; H04B 10/40

(52) U.S. Cl. CPC H04B 10/071; H04B 10/40

(57) ABSTRACT

Disclosed are techniques for time-interleaved phase-OTDR (ϕ-OTDR) with nested phase references that advantageously enables faster synchronization times. Our inventive techniques employ nested phase references which enables faster phase synchronization in time-interleaved ϕ-OTDR by transmitting a plurality of phase reference channels alongside the frequency-division multiplexed (FDM) channels. Compared with prior art in, more than one reference channel is used to achieve faster phase synchronization at the cost of higher bandwidth and system complexity.

### CROSS REFERENCE TO RELATED APPLICATIONS

This application claims the benefit of U.S. Provisional Patent Application Ser. No. 63/666,283 filed Jul. 1, 2024, the entire contents of which is incorporated by reference as if set forth at length herein.

### FIELD

This application relates generally to Optical Time-Domain Reflectometry (OTDR). More particularly, it pertains to time-interleaved phase-OTDR with nested phase references.

### BACKGROUND

In distributed acoustic sensing (DAS) based on phase optical time-domain reflectometry (ϕ-OTDR), a time-varying phase ϕ(z, t) is recovered for each section of the fiber under test (FUT), which is also sometimes known as a “sensor point”. The time-resolution of ϕ(z, t) is controlled by the repetition period of the pulse train Tₚ, while spatial resolution is controlled by the bandwidth of the pulse

$$Δ z = \frac{c}{2 {n}_{eff}} T .$$

When the FUT is long, it necessarily leads to poor time-resolution, thus reducing the Nyquist frequency

$$\frac{1}{2 {T}_{p}}$$

at which environmental perturbation can be sampled. This may be undesirable if the environmental perturbation has high frequency content. Moreover, if the perturbation is large, the phase may change by more than 2π between time samples, and the ϕ(z, t) recovered from ϕ-OTDR will not be able to follow the environmental change.

### SUMMARY

An advance in the art is made according to aspects of the present disclosure directed to time-interleaved phase-OTDR (ϕ-OTDR) with nested phase references that advantageously enables faster synchronization times.

In sharp contrast to the prior art, our inventive technique employs nested phase references which enables faster phase synchronization in time-interleaved ϕ-OTDR by transmitting a plurality of phase reference channels alongside the frequency-division multiplexed (FDM) channels. Compared with prior art in, more than one reference channel is used to achieve faster phase synchronization at the cost of higher bandwidth and system complexity.

Accordingly, we describe herein a new phase synchronization method in time-interleaved ϕ-OTDR using FDM, which enables faster synchronization time by employing a multitude of phase reference channels. In addition to the N FDM channels, we insert a multitude of phase reference channels and a “secondary reference” channel.

### BRIEF DESCRIPTION OF THE DRAWING

FIG. 1 is a schematic diagram showing an illustrative system architecture for environmental sensing using ϕ-OTDR according to aspects of the present disclosure.

FIG. 2 is a pair of plots showing illustrative pulse train launched by transmitter of FIG. 1 into the fiber under test (FUT), the pulse train having a repetition period of Tₚ, and the received signal is Rayleigh backscatter of the FUT, shown here as a scalar quantity y(z, t), but is dual-polarization in practice

FIG. 3A and FIG. 3B are plots Illustrating sampling rate enhancement using frequency-division multiplexing (FDM) in which FIG. 3A each FDM channel i, the probe signal repeats with a period of Tₚ, allowing the phase profile of the fiber ϕ(z, t) to be sampled at time resolution Tₚ at each distance z. The probe signals of different FDM channels are staggered at a spacing of T_{Δ}=Tₚ/N; and in FIG. 3B, although the same ϕ(z, t) is measured by all FDM channels, they have different DC phase offsets ϕ_{z}(i) which need to be determined and compensated before time interleaving.

FIG. 4 is a plot Illustrating the probe signals of our proposed scheme, where we employ a plurality of K reference channels (middle) and an additional “secondary reference” channel (bottom) to align the phase profiles ϕᵢ(z, t) recovered from different FDM channels. The probe pulses of each reference channel i repeat every T_{p,ref}=(N+K)T_{Δ}, which allows phase comparison between the FDM channels Sᵢ∈{i, K+i, . . . , (M−1)K+i} and their phase alignment as a group. The case for K=2 is shown here in the middle figure. To further align the phases of different groups Sᵢ, we employ a “secondary reference” with repetition rate T_{p,ref2}=(N+1)T_{Δ}.

### DETAILED DESCRIPTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and-depending on system configuration-can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As such, the sensing fiber serves as a sensor over its entire length, delivering real time information on physical/environmental surroundings, and fiber integrity/security. Furthermore, distributed fiber optic sensing data pinpoints a precise location of events and conditions occurring at or near the sensing fiber.

As those skilled in the art will understand and appreciate, a contemporary DFOS system generally includes an optical sensing fiber that in turn is connected to an interrogator. In some configurations, the interrogator may include a coded DFOS system that may employ a coherent receiver arrangement known in the art.

As is known further, contemporary interrogators are systems that generate an input signal to the optical sensing fiber and detect/analyzes reflected/backscattered and subsequently received signal(s). The signals received are analyzed, and an output is generated which is indicative of the environmental conditions encountered along the length of the fiber. The backscattered signal(s) received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates-for example - a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS generally operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

In distributed acoustic sensing (DAS) based on phase optical time-domain reflectometry (ϕ-OTDR), a time-varying phase ϕ(z, t) is recovered for each section of the fiber under test (FUT), which is also sometimes known as a “sensor point”.

A common method for recovering a ϕ-OTDR is to launch pulses of time duration T periodically into a fiber under test (FUT), where the repetition period Tₚ is longer than the round-trip time of the fiber

$${T}_{rt} = \frac{2 {n}_{eff} L}{c} ,$$

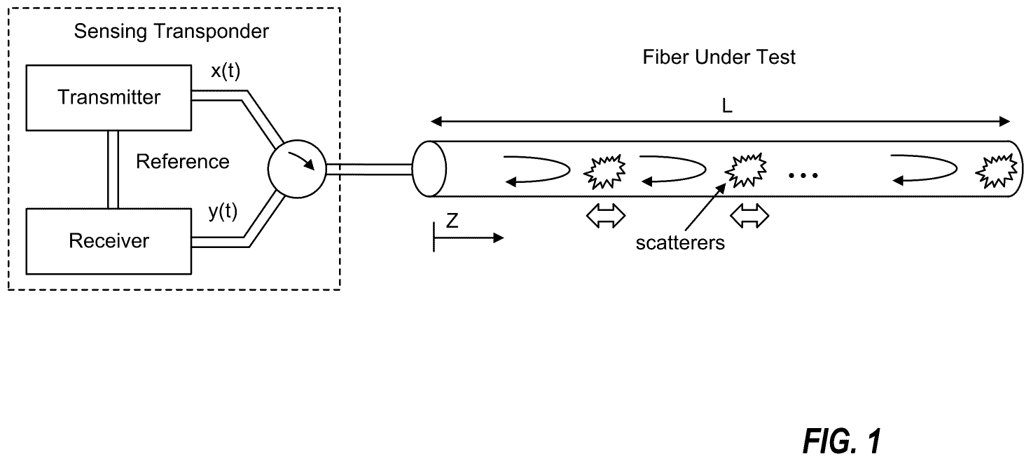

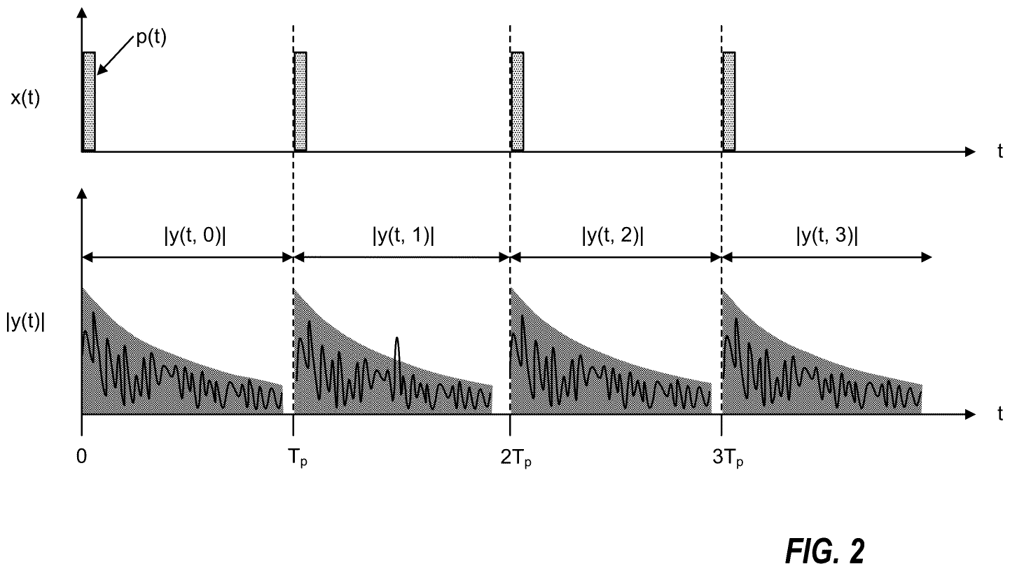

with L being the length of the FUT and n_{eff} being the effective index of propagation as schematically illustrated in FIG. 1, which is a schematic diagram showing an illustrative system architecture for environmental sensing using ϕ-OTDR according to aspects of the present disclosure. FIG. 2 illustrates a pair of plots showing illustrative pulse train launched by transmitter of FIG. 1 into the fiber under test (FUT), the pulse train having a repetition period of Tₚ, and the received signal is Rayleigh backscatter of the FUT, shown here as a scalar quantity y(z, t), but is dual polarization in practice.

The return signal is the Rayleigh impulse response y(z, t) of the FUT. Environmental perturbations resulting in change in temperature or strain alters the optical path length between the scatters in each section of fiber. Assuming scalar quantities for the moment, a phase profile ϕ(z, t) can be constructed by taking the differential product y_{Δ}(z, t)≐y(z+ΔZ_{g}, t)y*(z, t) between the Rayleigh impulse response at two point separated by a gauge length Δz_{g}, followed by taking the unwrapped phase ϕ(z,t)=∠y_{Δ}(z,t). Methods to deduce ϕ(z,t) taking polarization into consideration are known in the art (see, e.g., E. Ip, F. Ravet, H. Martins, M.-F. Huang, T. Okamoto, S. Han, C. Narisetty, J. Fang, Y.-K. Huang, M. Salemi, E. Rochat, F. Briffod, A. Goy, M. R. Fernández-Ruiz and M. González Herráez, “Using Global Existing Fiber Networks for Environmental Sensing,” Proc. IEEE, vol. 110, no. 11, pp. 1853-1888 November 2022.).

The time-resolution of ϕ(z, t) is controlled by the repetition period of the pulse train Tₚ, while spatial resolution is controlled by the bandwidth of the pulse

$$Δ z = \frac{c}{2 {n}_{eff}} T .$$

When the FUI is long, it necessarily leads to poor time-resolution, thus reducing the Nyquist frequency

$$\frac{1}{2 {T}_{p}}$$

at which environmental perturbation can be sampled. This may be undesirable if the environmental perturbation has high frequency content. Moreover, if the perturbation is large, phase may change by more than 2π between time samples, and the ϕ(z, t) recovered from ϕ-OTDR will not be able to follow the environmental change.

It is possible to improve temporal resolution by using N-fold frequency-division multiplexing (FDM). Suppose probe pulses with repetition period Tₚ are launched at each FDM frequency, but the pulses of different FDM channels are staggered at a spacing of T_{Δ}=Tₚ/N. In the absence of noise, the ϕ-OTDR obtained at the i-th FDM channel will be ϕᵢ(z, t)=(z, t+(i−1)T_{Δ})+ϕ_{z}(i), where ϕ(z, t) is the true phase profile of the fiber, and ϕ_{z}(i) is a DC offset that is different for each FDM channel and at each distance.

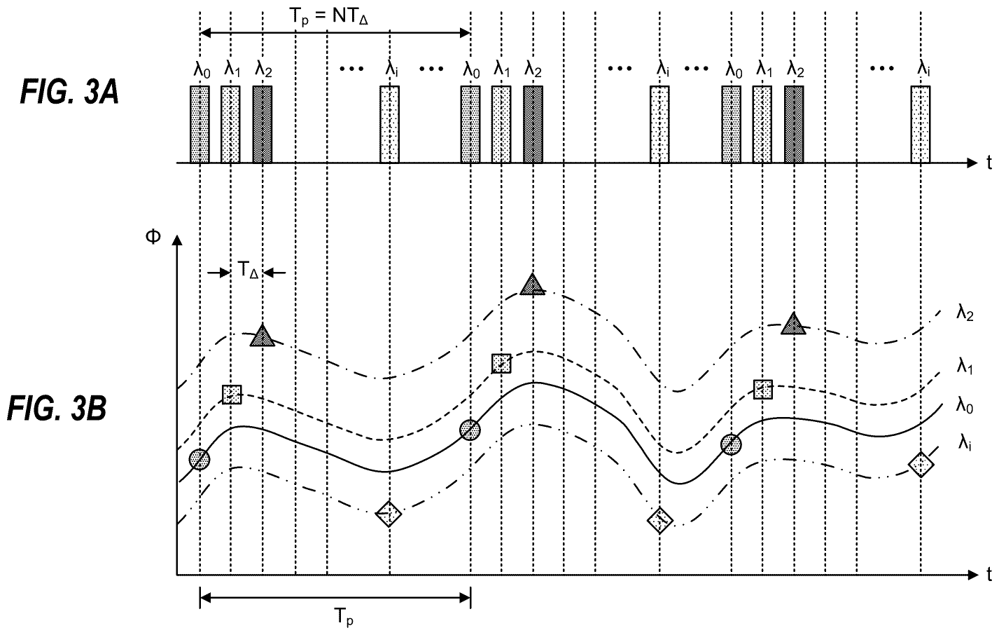

This is illustrated in FIG. 3A and FIG. 3B, which are plots Illustrating sampling rate enhancement using frequency-division multiplexing (FDM) in which FIG. 3A each FDM channel i, the probe signal repeats with a period of Tₚ, allowing the phase profile of the fiber ϕ(z, t) to be sampled at time resolution Tₚ at each distance z. The probe signals of different FDM channels are staggered at a spacing of T_{Δ}=Tₚ/N; and in FIG. 3B, although the same ϕ(z, t) is measured by all FDM channels, they have different DC phase offsets ϕ_{z}(i) which need to be determined and compensated before time interleaving.

To stitch the phase estimates using time-interleaving, the phase offsets ϕ_{z}(i) must be estimated and compensated.

A prior art method (see, e.g., Y. Wakisaka, D. lida, Y. Koshikiya and N. Honda, “Sampling rate enhancement and fading suppression of ϕ-OTDR with frequency division multiplex technique,” J. Lightw. Technol., vol. 40, no. 3, pp. 822-836, February 2022.) has been proposed where a reference frequency channel with repetition period T_{p,ref}=(N+1)T_{Δ} is transmitted alongside the N FDM channels. As probe pulses in successive frames of the reference channel are aligned with a different FDM channel, it enables the relative phase offset between FDM channel i and the reference, ϕ_{z}(i)-ϕ_{z,ref}, to be determined and then compensated. The drawback of this method is that it takes N reference channel frames to synchronize all N FDM channels. In practice, ϕ_{z}(i) may drift slowly due to low-frequency laser phase noise. Suppose the FUT is a 10,000-km submarine link. The repetition period Tₚ of each FDM channel must exceed ˜100 ms. Suppose N=100 frequencies are time-interleaved to enable the cable environment to be sampled at 1 KHz. The current method requires just over 10 seconds to synchronize the phases of all 100 FDM channels.

One goal of this invention is to enable faster synchronization time. We accomplish this by using an architecture of nested phase references. As we have previously noted, our inventive techniques enable faster phase synchronization in time-interleaved ϕ-OTDR by transmitting a plurality of phase reference channels alongside the FDM channels. Compared with prior art, more than one reference channel is used to achieve faster phase synchronization at the cost of higher bandwidth and system complexity. Stated alternatively, our inventive techniques transmits a plurality of phase reference channels alongside the FDM channels that recover the phase profile of the fiber under test (FUT).

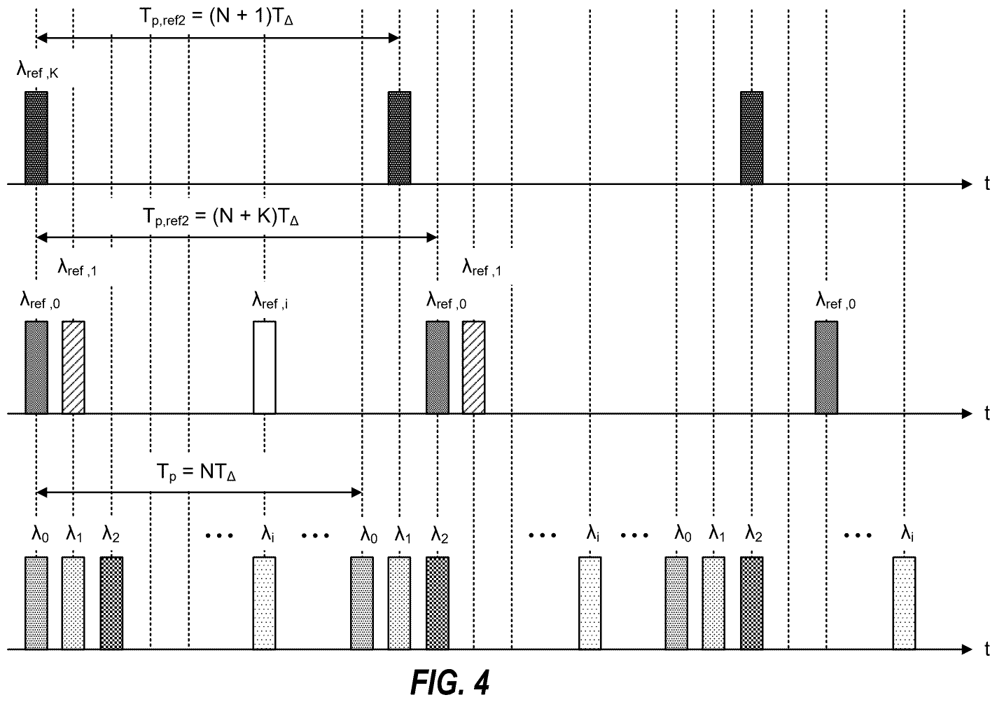

We describe our new phase synchronization method in time-interleaved ϕ-OTDR using FDM, which enables faster synchronization time by employing a multitude of phase reference channels. Our inventive scheme is shown in FIG. 4., which is a plot Illustrating the probe signals of our proposed scheme, where we employ a plurality of K reference channels (middle) and an additional “secondary reference” channel (bottom) to align the phase profiles ϕᵢ(z, t) recovered from different FDM channels. The probe pulses of each reference channel i repeat every T_{p,ref}=(N+K)T_{Δ}, which allows phase comparison between the FDM channels Sᵢ∈{i, K+i, . . . , (M−1)K+i} and their phase alignment as a group. The case for K=2 is shown here in the middle figure. To further align the phases of different groups Sᵢ, we employ a “secondary reference” with repetition rate T_{p,ref2}=(N+1)T_{Δ}.

In addition to the N FDM channels, we insert a multitude of phase reference channels and a “secondary reference” channel.

The repetition period of each reference channel is T_{p,ref}=(N+K)T_{Δ}, where K is a positive integer. For simplicity, we assume that N=MK is divisible by K. In the m-th frame, the probe pulse of reference channel i is synchronized with the probe pulse of FDM channel (mK+i) mod N. Thus, after M reference frames, the phase of reference channel i has been compared against FDM channels Sᵢ∈{i, K+i, . . . , (M−1)K+i} at each distance, allowing the phase offsets of all the FDM channels in this group to be compensated.

To compensate the remaining relative phase offsets between different groups Sᵢ, we insert a “secondary reference” channel whose probe pulses are launched at a repetition period of T_{p,ref2}=(N+1)T_{Δ}. Just as in our original scheme, this enables a final alignment of all K groups Sᵢ for 0≤i<K, as successive probe pulses of this “secondary reference” channel is aligned with a different group Sᵢ, allowing their comparison with the “secondary reference” at each distance, and this difference is then subsequently compensated.

The synchronization time of our modified scheme is dependent on K. Each reference channel requires M frames at a repetition period T_{p,ref}=(N+K)T_{Δ} to cycle through all the FDM channels within group Sᵢ. Thus, the first synchronization period is T_{sync,1}=(M(N+K)/N)Tₚ. The secondary reference channel requires K frames at repetition period T_{p,ref2}=(N+1)T_{Δ} to synchronize all K groups, which gives a second synchronization period of T_{sync,2}=(K(N+1)/N)Tₚ. The overall synchronization time is T_{sync}=max(T_{sync,1}, T_{sync,2}).

The scheme we originally proposed corresponds to K=1 and M=N, and requires no secondary reference, which leads to T_{sync}=(N+1)Tₚ. In our generalized scheme, one should choose K≈\sqrt{N} to minimize T_{sync}. In the limit where N is large, phase synchronization is achieved in T_{sync}≈\sqrt{N}Tₚ. For a 10,000-km FUT example where N=100, the ˜10 fold improvement in synchronization speed from ˜10 seconds to ˜1 second represents a substantial improvement and allows better system tolerance against low-frequency laser phase noise.

Although the technique described, as illustrated in FIG. 3A, FIG. 3B and FIG. 4 to show the use of rectangular pulses as probe signals, the method will work with other probe signals, including chirped pulses and other coded schemes such as Golay codes.

Although we described sampling rate enhancement in the context of FDM, it is in theory also possible with space-division multiplexing (SDM), such as over multicore fibers (MCF). In this case, the FDM and reference channels can be signals on spatial cores, and the described method will work provided inter-core delay skew is small relative to the spatial resolution time scale. It is also possible to realize the sampling rate enhancement channels and reference channels using a combination of both SDM and FDM.

While we have presented our inventive concepts and description using specific examples, our invention is not so limited. Accordingly, the scope of our invention should be considered in view of the following claims.

1. A distributed fiber optic sensing (DFOS) sensing system based on measurement of phase-optical time-domain reflectometry CHARACTERIZED IN THAT:
sampling time of an environmental perturbation is enhanced using a plurality of frequency division multiplexing (FDM) channels and time-interleaving phases recovered at each FDM channel.

2. The DFOS sensing system of claim 1 FURTHER CHARACTERIZED IN THAT:
to compensate for phase offset between phase waveforms recovered at each FDM channel, a plurality of primary phase reference channels and a secondary reference channel are inserted into OTDR pulse trains.

3. The DFOS sensing system of claim 2 FURTHER CHARACTERIZED IN THAT:
a pulse repetition rate of primary phase reference channels is set such that phase synchronization of a subset of the plurality of FDM channels is achieved.

4. The DFOS sensing system of claim 3 FURTHER CHARACTERIZED IN THAT:
a secondary reference channel allows a final phase synchronization of all the subsets of the plurality of FDM channels by setting an appropriate pulse repetition rate.

5. The DFOS sensing system of claim 4 FURTHER CHARACTERIZED IN THAT:
the FDM channels and reference channels transmit a train of chirped pulses exhibiting repetition rates exceeding a round-trip time of a fiber under test.

6. The DFOS sensing system of claim 5 FURTHER CHARACTERIZED IN THAT:
the FDM channels and reference channels comprise space-division multiplexing (SDM) channels.
